(19) United States
(12) Patent Application Publication
(10) Pub. No.: US 2025/0178075 A1
(43) Pub. Date: Jun. 5, 2025

(54) ADDITIVELY PRODUCED ELECTROPLATED FOUNDRY TOOLING

(71) Applicant: Mueller International, LLC, Atlanta, GA (US)

(72) Inventors: Jason White Bradley, Soddy-Daisy, TN (US); Joseph Anthony Alnas, III, Cleveland, TN (US)

(21) Appl. No.: 18/782,657

(22) Filed: Jul. 24, 2024

Related U.S. Application Data
(60) Provisional application No. 63/604,587, filed on Nov. 30, 2023.

(51) Int. Cl. B22C 9/02; B22C 7/00; B22C 7/06; B22D 19/00; B33Y 10/00; B33Y 40/20; B33Y 80/00; C25D 7/00

(52) U.S. Cl. CPC B22C 9/02; B22C 7/00; B22C 7/06; B22D 19/00; B33Y 10/00; B33Y 40/20; B33Y 80/00; C25D 7/00

(57) ABSTRACT

A method for manufacturing foundry tooling comprises the steps of forming a foundry tooling body in accordance with a predetermined model, and electroplating the foundry tooling body to add a metallic coating to at least a portion of the foundry tooling body to define at least one plated tooling body surface, wherein each plated tooling body surface is configured to contact a malleable blank to produce a sand mold suitable for manufacturing a casting.

### CROSS-REFERENCE TO RELATED APPLICATION

This application claims the benefit of U.S. Provisional Patent Application Ser. No. 63/604,587, filed Nov. 30, 2023, the entire disclosure of which is hereby specifically and entirely incorporated by reference.

### TECHNICAL FIELD

This disclosure relates to the manufacture of foundry tooling. More specifically, this disclosure relates to a method of manufacturing a pattern or a core box, both of which can be used in the manufacture of a casting. This disclosure also relates to a method of manufacturing a casting using the foundry tooling so produced.

### BACKGROUND

“Foundry tooling,” in the context of the present disclosure, means an object that is used to manufacture a mold that is used to create a casting or cast part, where the object is a pattern (used to make a mold that forms the outside of a casting) a core box (used to make cores that are used in a mold to form an inside portion, void, or hollow area of a casting), or a cope and drag of a pattern. Foundry tooling can be manufactured using three-dimensional printing (also called additive manufacturing (AM)) techniques such as fused deposition modeling (FSM), digital light projection (DLP), or stereolithography (SLA). However, the use of AM techniques to manufacture foundry tooling has realized limited adoption when compared to other manufacturing techniques. The primary limitations that have prevented this transition include premature wear compared to traditional tool steel, layer line (striation) issues that pose dimensional or mold quality issues, and physical and/or chemical issues related to such parameters as heat resistance, UV vulnerabilities, and mechanical properties. Those limitations have prevented this industry from realizing the tremendous time savings and cost savings potential of AM techniques, and have relegated AM to not much more than a prototyping tool as a precursor to constructing foundry tooling using traditional materials.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In accordance with some aspects of the present disclosure, a method of manufacturing a foundry tooling comprises the steps of forming a foundry tooling body in accordance with a predetermined model, and electroplating the foundry tooling body to add a metallic coating to at least a portion of the foundry tooling body to define at least one plated tooling body surface. Each plated tooling body surface is configured to contact a malleable blank to produce a sand mold suitable for manufacturing a casting.

In other aspects of the present disclosure, a method of manufacturing a casting comprises the steps of manufacturing a foundry tooling in accordance with the method of the immediately-preceding paragraph, the foundry tooling defining a first configuration; loading the foundry tooling into a molding machine; using the molding machine to bring the foundry tooling into contact with a malleable blank comprised of a mixture of sand and a resin; and using the molding machine to further urge the foundry tooling toward the malleable blank such that the foundry tooling exerts pressure upon the malleable blank until the malleable blank transforms into a sand mold, the sand mold defining a second configuration complementary to the first configuration, wherein the second configuration defines at least one sand mold cavity.

Various implementations described in the present disclosure can comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations can be realized and obtained by means of the systems, methods, features particularly pointed out in the appended claims. These and other features will become more fully apparent from the following description and appended claims, or can be learned by the practice of such exemplary implementations as set forth hereinafter.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a perspective view illustrating a step in the three-dimensional printing of a foundry tooling body constructed in accordance with aspects of the present disclosure.

FIG. 2 is a perspective view illustrating a cleaning step concerning the foundry tooling body printed in FIG. 1.

FIG. 3 is a perspective view of a pair of foundry tooling bodies undergoing an electroplating step in accordance with some methods of the present disclosure.

FIG. 4 is a perspective view, partially in section, of a completed and plated foundry tooling produced in accordance with some methods of the present disclosure.

FIG. 5 is an enlarged detail view of a portion of the completed and plated foundry tooling encircled in FIG. 4.

FIG. 6 is a top perspective view of the foundry tooling illustrated in FIG. 4.

FIG. 7 is a perspective view of the plated foundry tooling of FIG. 6 loaded into a molding machine.

FIG. 8 is a top perspective view of a sand mold produced by the foundry tooling of FIG. 6 and the molding machine of FIG. 7.

FIG. 9 is a flow chart for method steps to be performed in accordance with some aspects of the present disclosure.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

Reference numerals common to more than one accompanying figure identify the same component throughout the figures.

As used throughout, the singular forms “a,” “an” and “the” include plural referents unless the context clearly dictates otherwise. Thus, for example, reference to a quantity of one of a particular element can comprise two or more such elements unless the context indicates otherwise.

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or substantially,” it will be understood that the particular value forms another aspect. It will be further understood that the endpoints of each of the ranges are significant both in relation to the other endpoint, and independently of the other endpoint.

For purposes of the present disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list.

To simplify the description of various elements disclosed herein, the conventions of “top,” “bottom,” “side,” “upper,” “lower,” “horizontal,” and/or “vertical” may be referenced. Unless stated otherwise, “top” describes that side of the system or component that is facing upward and “bottom” is that side of the system or component that is opposite or distal the top of the system or component and is facing downward. Unless stated otherwise, “side” describes that an end or direction of the system or component facing in horizontal direction. “Horizontal” or “horizontal orientation” describes that which is in a plane aligned with the horizon. “Vertical” or “vertical orientation” describes that which is in a plane that is angled at 90 degrees to the horizontal.

As stated above, the term “foundry tooling” encompasses patterns, core boxes, and copes and drags of patterns. Examples of core boxes, including cold boxes, which are core boxes that are not heated during the process of making cores with the cold box, are taught in U.S. Pat. No. 11,458,532, which issued Oct. 4, 2022, the disclosure of which is hereby incorporated by reference herein in its entirety. In a method executed in accordance with aspects of the present disclosure, a body of a foundry tooling (also called a base model or a core box), is formed by any suitable AM technique, and the formed body of the foundry tooling undergoes an electroplating step. Examples of AM processes are shown and described in U.S. Pat. No. 10,558,198, which issued on Feb. 11, 2020, the disclosure of which is hereby incorporated by reference herein in its entirety. The electroplating provides the formed body with a metallic (such as nickel) coating. Advantageously, the method produces a hardened metallic finish that provides additional wear resistance and toughness, UV protection, heat resistance, humidity protection, and cleaner separation between the negative and a mold produced with the negative during a mold forming process. The method also substantially shortens tooling development cycles, which can now be measured in days rather than months for many types of foundry tooling.

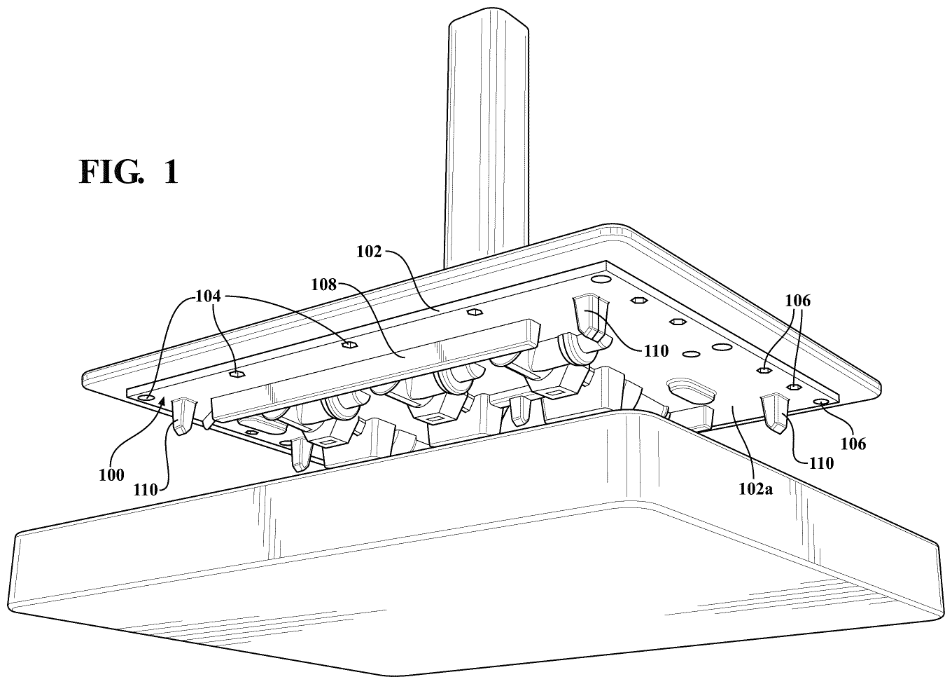

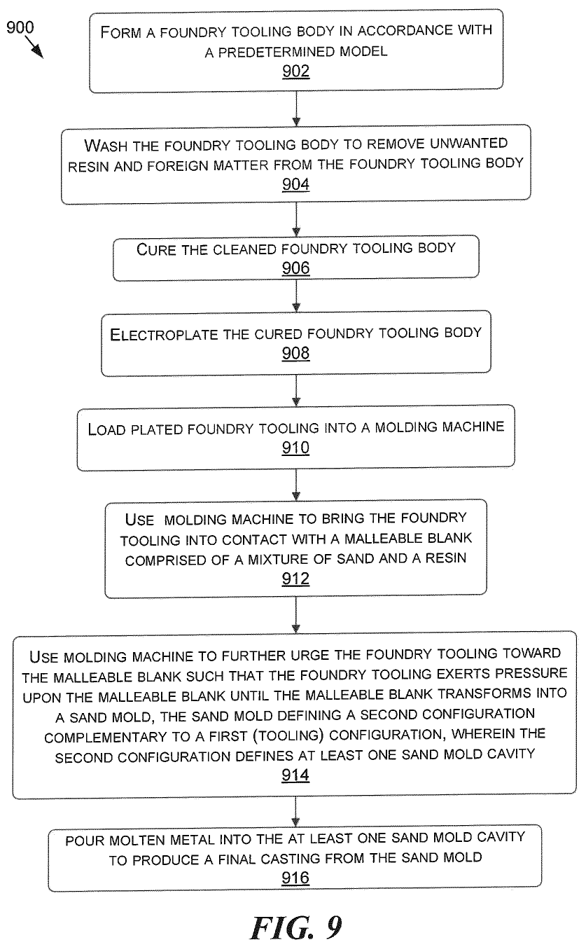

FIG. 1 is a perspective view illustrating an example of step 902 in the method of FIG. 9, namely, a step in the three-dimensional printing of a foundry tooling body 100 constructed in accordance with some aspects of the present disclosure, which is shown for exemplary purposes in FIG. 1 and in subsequent figures herein as a pattern body, but it is to be understood that foundry tooling body 100 can take the form of either a pattern body or a core box body. The material comprising the formed foundry tooling body 100 can comprise a polymer containing carbon fibers defining a carbon-fill percentage of approximately 20%, produced by the three-dimensional printing method disclosed in U.S. Pat. Nos. 11,458,532 and/or 10,558,198, each incorporated by reference in their entireties as stated above. Other AM techniques are also contemplated as being within the scope of the present disclosure in terms of how the foundry tooling body 100 can be formed, and in terms of what material can comprise a foundry tooling body. The composition of the foundry tooling body 100 can vary depending upon which AM process is used. For example, the composition of foundry tooling body 100 can be any material suitable for DLP, suitable for SLA, or suitable for FSM. In any of the AM techniques, the foundry tooling body 100 is formed in accordance with a predetermined model that can be expressed as machine-readable instructions executed by computing system operatively connected to the AM hardware employed to form the foundry tooling body 100. In other aspects of the present disclosure, the foundry tooling body 100 can be formed through implementing a technique other than AM, in which case the foundry tooling body may be composed of a more traditional material, such as metal, and in which case the foundry tooling can comprise a cope and drag of a pattern.

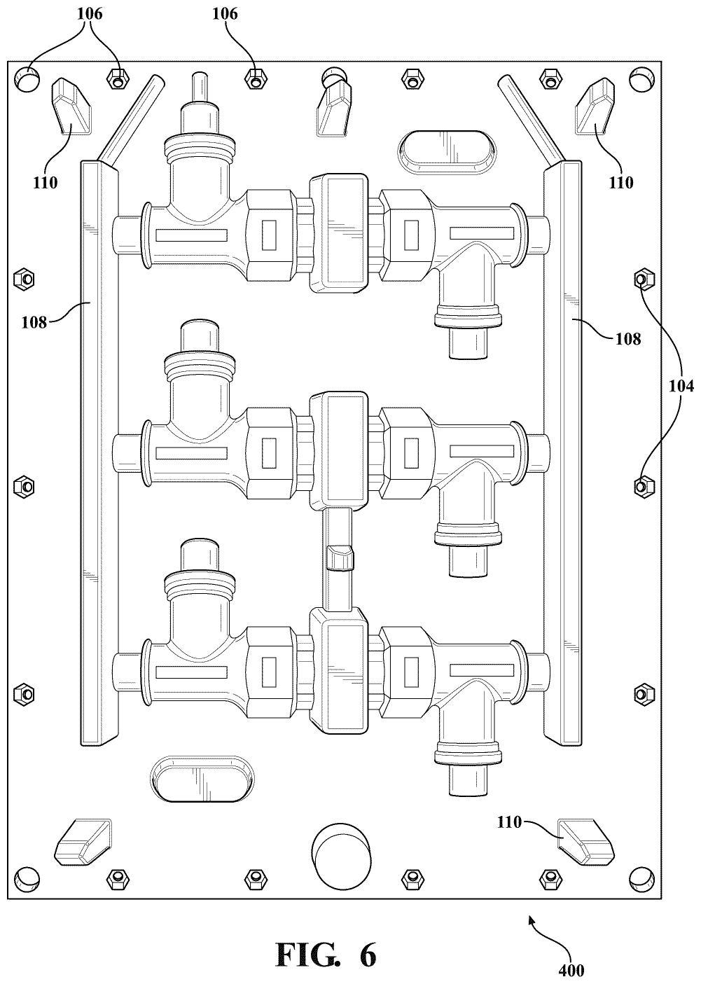

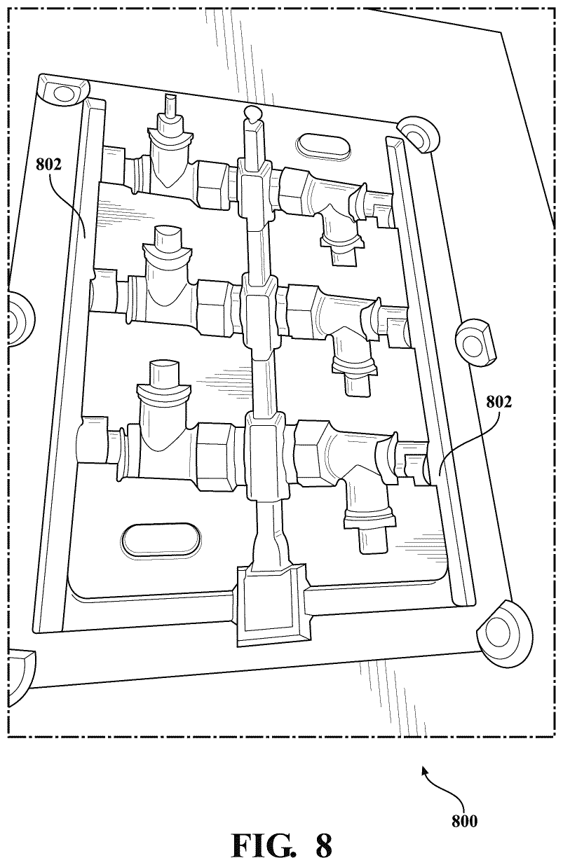

In the example of FIG. 1, the foundry tooling body 100 is configured to produce a sand mold that functions as a negative of a final casting or cast part to be produced, as will be further discussed herein with reference to FIG. 8. In the example of FIG. 1, the foundry tooling body 100 defines a plate 102 defining an outer surface 102a, a plurality of longitudinally arranged apertures 104 extending through the surface 102a, and a plurality of laterally arranged apertures 106 also extending through the surface 102a. One or more ribs 108 and a plurality of lugs 110 can extend outwardly (substantially downwardly in the orientation shown in FIG. 1) from the surface 102a. The configuration of the foundry tooling body 100 depicted in FIG. 1 is merely exemplary and can assume any configuration depending on the configuration desired for the mold ultimately produced with a completed (plated) foundry tooling 400 (FIG. 6).

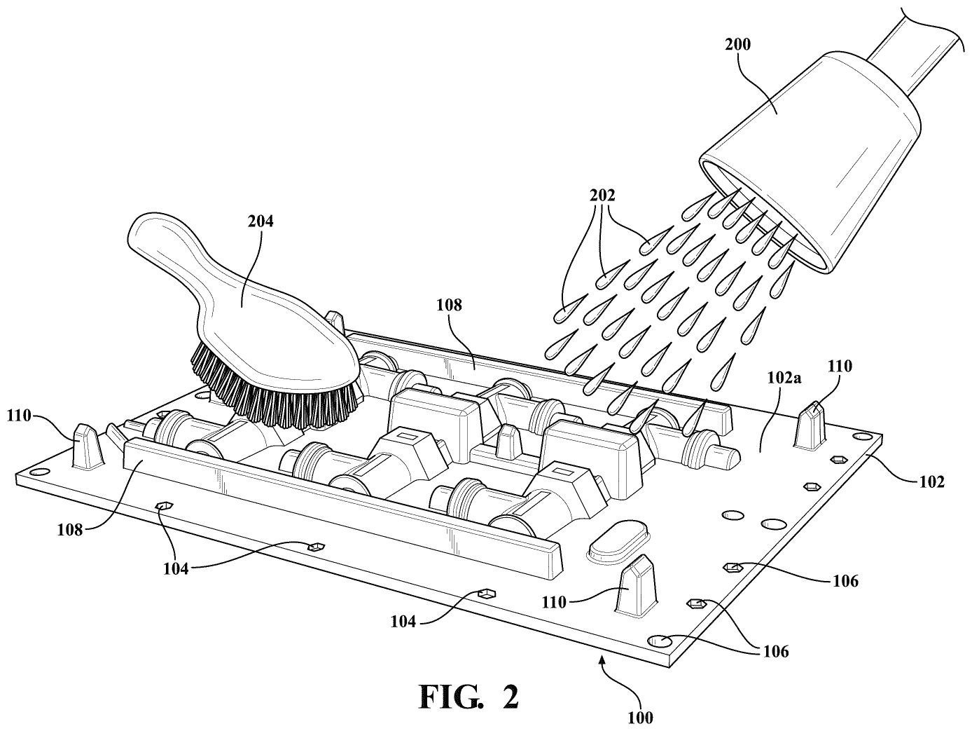

FIG. 2 is a perspective view illustrating an example of step 904 in the method of FIG. 9, namely, a cleaning step concerning the foundry tooling body 100, which is placed in proximity to a fluid head 200. A liquid detergent 202, such as isopropyl alcohol or a commercially available agent, exits the fluid head 200 under pressure to impinge exposed surfaces of the foundry tooling body 100. A brush 204 can be used to manually further loosen and remove any foreign matter, especially any resin remaining from the forming step discussed above with regard to FIG. 1, from the surface of the foundry tooling body 100.

After the cleaning step of in FIG. 2 is completed, the foundry tooling body 100 is cured (FIG. 9, step 906). The curing process can vary with the type of unit that performs the AM process exemplified in FIG. 1. One example of a curing method for a part formed by SLA is irradiation of the formed part with ultraviolet (UV) light, and this can be performed by various products such as the PostCure™ 1050 post-processing system sold by 3D Systems, Inc., the system capable of irradiating a formed part with UV light from multiple UV light modules. Such a system can also optionally dry the part to remove excess solvent prior to curing.

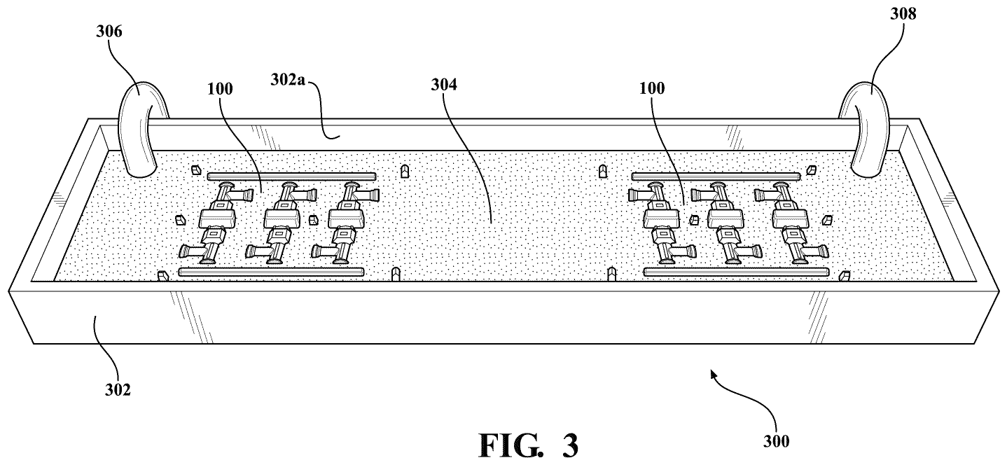

FIG. 3 is a perspective view of a pair of foundry tooling bodies 100 undergoing an electroplating step (FIG. 9, step 908) at an electroplating station 300, in accordance with some methods of the present disclosure. Each of the foundry tooling bodies 100 are shown configured in the manner discussed above with regard to FIG. 1. Although FIG. 3 shows two foundry tooling bodies 100 simultaneously undergoing an electroplating step, a lesser or greater number of foundry tooling bodies 100 can undergo this step at the electroplating station 300. As shown in FIG. 3, the electroplating station 300 can comprise a pan 302 defining a chamber 302a configured to hold a quantity of electroplating fluid 304 sufficient to completely cover the foundry tooling bodies 100, if necessary for at least a portion of the electroplating process. The electroplating station 300 can further comprise a power supply (not shown) electrically connected to the pan 302, such that when the power supply is activated, electrical current causes the electroplating fluid 304 to ionize, causing metallic ions to precipitate on the submerged surfaces of the foundry tooling bodies 100. The electroplating station 300 may further comprise a pair of electroplating fluid supply tubes 306,308, through which the electroplating fluid 304 may be admitted into, or be evacuated from, the pan 302 responsive to action of one or more pumps (not shown) operatively communicating with the supply tubes 306,308.

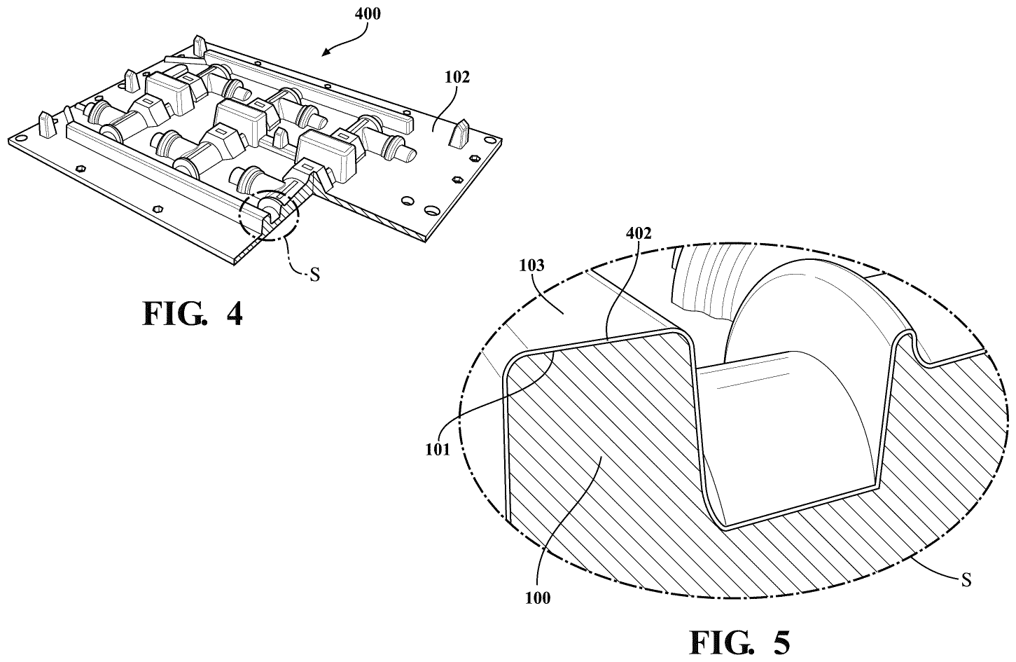

FIGS. 4 and 5 illustrate a completed and plated foundry tooling 400 produced in accordance with some methods of the present disclosure. FIG. 4 illustrates the plated foundry tooling 400 in a perspective view, partially in section with respect to a portion of the plate 102 being cut away for illustrative purposes. The sectional view includes an encircled section S, which is enlarged in the detail view of FIG. 5. The foundry tooling 400 is configured identically to the foundry tooling body 100 discussed with regard to FIGS. 1-3, above, except that that the foundry tooling 400 includes a metallic coating 402 covering the foundry tooling body 100. The metallic coating 402 need not encapsulate the foundry tooling body 100 in its entirety, as shown in FIG. 5. Instead, for example, the metallic coating 402 can be applied only on tooling body surfaces (such as tooling body surface 101 in FIG. 5) that will define plated tooling body surfaces, wherein each plated tooling body surface (such as plated tooling body surface 103 in FIG. 5) is configured to contact a malleable blank to produce a sand mold (such as sand mold 800 in FIG. 8) suitable for manufacturing a casting. The metallic coating 402 can be produced by the electroplating process discussed above with regard to FIG. 3. In various aspects, the metallic coating 402 can be composed of nickel. However, nickel is just one example of the materials of which the metallic coating can be composed, and any commonly used plating material can be used to compose the metallic coating 402. For further example, the metallic coating 402 can be composed of a combination of nickel and copper, where copper is a base coat and nickel is a top coat, the resulting plating having a thickness than can fall within the range of from and including 0.006 inches to and including 0.008 inches. As stated above, the metallic coating 402 provides additional wear resistance and toughness, UV protection, heat resistance, humidity protection, and cleaner separation between the completed foundry tooling 400 and a sand mold 800 (FIG. 8) produced with the foundry tooling 400 in the manner discussed herein with regard to FIG. 8.

FIG. 6 is a top perspective view of the completed and plated foundry tooling 400 illustrated in FIG. 4, produced in accordance with some methods of the present disclosure. The particular configuration of the completed and plated foundry tooling 400 is the same as that illustrated for the foundry tooling body 100 in FIGS. 1-3, above. FIG. 6 provides a complete view of the configuration details.

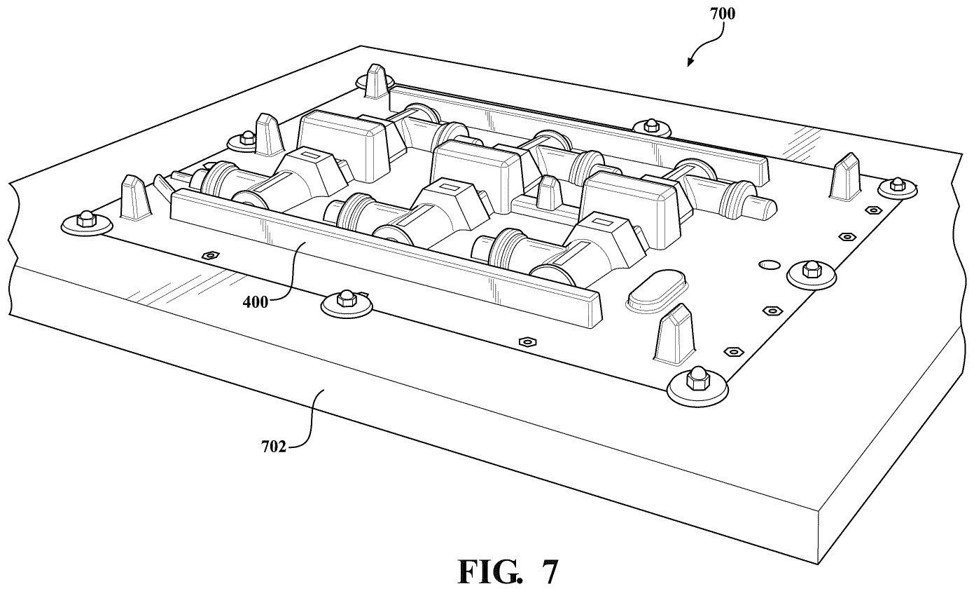

FIG. 7 is a perspective view of the completed foundry tooling 400 of FIG. 6 loaded into a molding machine 700 (FIG. 9, step 910), and in the example illustrated in FIG. 7, mounted onto a jig 702 of the molding machine 700. The molding machine 700 can be any suitable molding machine on which the foundry tooling 400 can be mounted, an example of which is a tooling machine commercially available from the DISA Group under the trademark DISA®, Model Number 20/24. The foundry tooling 400 can be mounted to the jig 702 by any suitable means, such as a plurality of fasteners extending through the apertures 104, 106 (FIG. 6). In accordance with step 912 of FIG. 9, the jig 702 of the molding machine 700 is moved in a direction that brings the foundry tooling 400 into contact with a malleable blank (not shown). In various aspects of the present disclosure, it shall be understood that, even though FIG. 7 shows only a single foundry tooling element 400 loaded into the molding machine 700, two tooling elements can be installed in the molding machine 700, such that the malleable blank would be pressed on both sides, with one tooling element pressing into each side. The malleable blank can be composed of a mixture of sand and resin to create an unbonded sand mixture. As discussed in the incorporated U.S. Pat. No. 11,458,532, for example and without limitation, the resin can be a phenolic-urethane resin. Such a composition allows the malleable blank to change shape responsive to pressure exerted by the foundry tooling 400. In accordance with step 914 of FIG. 9, the jig 702 is further urged toward the malleable blank by the molding machine 700, such that the foundry tooling 400 exerts pressure upon the malleable blank until the blank transforms into the sand mold 800 (FIG. 8). After a predetermined time, the mold machine 700 moves the jig 702 in a direction away from the sand mold 800, to separate the foundry tooling 400 from the sand mold 800. The sand mold 800 is then removed from the mold machine 700. If desired, the foundry tooling 400 can also be removed from the molding machine 700.

FIG. 8 is a top perspective view of a sand mold 800 produced by the foundry tooling 400 of FIG. 6. As stated in step 914 of FIG. 9, the sand mold 800 defines a configuration complementary to the configuration of the foundry tooling 400. For example, where the foundry tooling 400 defines the ribs 108 (FIG. 6), the sand mold 800 defines channels 802 each having a depth equal to the height of the ribs 108. The configuration of the sand mold 800 functions as a negative for the configuration to be assumed by a completed casting produced with the sand mold 800. In particular, the configuration of the sand mold 800 defines at least one sand mold cavity, for example, the channels 802. Molten metal, such as cast iron, ductile iron, bronze, or brass is then poured into each of the sand mold cavities of the sand mold 800 to produce a final metallic casting from the sand mold 800 (FIG. 9, step 916). Although cast iron, ductile iron, bronze, and brass have been recited here as examples of the molten metal, it is to be understood that the present disclosure is not limited in scope to those molten metal materials, and that other suitable molten metal materials are encompassed within the scope of the present disclosure.

Although several aspects have been disclosed in the foregoing specification, it is understood by those skilled in the art that many modifications and other aspects will come to mind to which this disclosure pertains, having the benefit of the teaching presented in the foregoing description and associated drawings. It is thus understood that the disclosure is not limited to the specific aspects disclosed hereinabove, and that many modifications and other aspects are intended to be included within the scope of any claims that can recite the disclosed subject matter.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, can be executed out of order from that shown or discussed, including substantially concurrently or in reverse order, depending on the functionality involved, as would be understood by those reasonably skilled in the art of the present disclosure. Many variations and modifications can be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A method of manufacturing foundry tooling, comprising the steps of:
forming a foundry tooling body in accordance with a predetermined model; and
electroplating the foundry tooling body to add a metallic coating to at least a portion of the foundry tooling body to define at least one plated tooling body surface, wherein each plated tooling body surface is configured to contact a malleable blank to produce a sand mold suitable for manufacturing a casting.

2. The method of claim 1, wherein the foundry tooling body is formed by additive manufacturing.

3. The method of claim 1, wherein the foundry tooling body is composed of a material comprising a polymer containing carbon fibers defining a carbon-fill percentage of approximately 20%.

4. The method of claim 1, wherein the foundry tooling is at least one of a pattern, a core box, and a cope and drag of a pattern.

5. The method of claim 1, wherein the metallic coating is composed of nickel.

6. The method of claim 1, wherein the metallic coating has a thickness from and including 0.006 inches to and including 0.008 inches.

7. The method of claim 1, wherein the metallic coating is composed of a combination of nickel and copper.

8. The method of claim 7, wherein the copper is a base coat and the nickel is a top coat.

9. The method of claim 7, wherein the metallic coating has a thickness from and including 0.006 inches to and including 0.008 inches.

10. The method of claim 1, further comprising the step of after the forming step, washing the foundry tooling body.

11. The method of claim 10, further comprising the step of, after the washing step, curing the foundry tooling body.

12. A method of manufacturing a casting, comprising the steps of:
manufacturing foundry tooling in accordance with the method of claim 1, the foundry tooling defining a first configuration;
loading the foundry tooling into a molding machine;
using the molding machine to bring the foundry tooling into contact with a malleable blank comprised of a mixture of sand and a resin; and
using the molding machine to further urge the foundry tooling toward the malleable blank such that the foundry tooling exerts pressure upon the malleable blank until the malleable blank transforms into a sand mold, the sand mold defining a second configuration complementary to the first configuration, wherein the second configuration defines at least one sand mold cavity.

13. The method of claim 12, further comprising the step of pouring molten metal into the at least one sand mold cavity to produce a final casting from the sand mold.

14. The method of claim 13, wherein the molten metal is comprised of one of cast iron, ductile iron, bronze, or brass.

15. The method of claim 12, wherein the foundry tooling is at least one of a pattern, a core box, and a cope and drag of a pattern.

16. The method of claim 12, wherein the foundry tooling body is composed of a material comprising a polymer containing carbon fibers defining a carbon-fill percentage of approximately 20%.

17. The method of claim 12, wherein the metallic coating has a thickness from and including 0.006 inches to and including 0.008 inches.

18. The method of claim 12, wherein the metallic coating is composed of a combination of nickel and copper.

19. The method of claim 18, wherein the copper is a base coat and the nickel is a top coat.

20. The method of claim 18, wherein the metallic coating has a thickness from and including 0.006 inches to and including 0.008 inches.
